(19) United States
(12) Patent Application Publication
(10) Pub. No.: US 2014/0149233 A1
(43) Pub. Date: May 29, 2014

(54) Interactive system and method of products, services, intelligent information and the like

(71) Applicant: Jianlin Dai, Changsha City (CN)

(72) Inventor: Jianlin Dai, Changsha City (CN)

(21) Appl. No.: 13/694,387

(22) Filed: Nov. 26, 2012

(51) Int. Cl. G06Q 30/02

(52) U.S. Cl. CPC G06Q 30/0277
USPC 705/14.73

(57) ABSTRACT

An interactive system includes an interactive society involving places and products being simulated as a real social network, and an user interactive module adapted for a user to configure a virtual character and to play a role in the interactive society, and a business module implanting different advertisements into places and products in the interactive society to interact with the user.

### CROSS REFERENCE OF RELATED APPLICATION

This is a non-provisional application of a provisional application, application No. 61/629,746, filed Nov. 25, 2011.

### BACKGROUND OF THE PRESENT INVENTION

1. Field of Invention

The present invention relates to an online simulation game, and more particular to an interactive character simulation system and method thereof, wherein the user is able to create a virtual character to interact with others.

2. Description of Related Arts

Simulation game is considered as one of the popular electronic games for enabling the player to create a virtual character. For example, a virtual pet simulation game is provided as a portable electronic game console having a display and a control button. The player is able to select a pet character, such as a dog type, cat type or the like, being digitally simulated in the game console and to interact with the pet character. In addition, the player can feed the pet character by pressing the control button when a “hungry” status is shown on the display or clean the living area of the pet character when a “sanitary” status is shown on the display. The game console will guide the development and health of the pet character will be maintained. However, such virtual pet simulation game can only provide interact between the pet character and the player.

Another simulation game can be an online game that the player can also build a virtual character to interact with virtual characters of different players. However, such online game can only one particular game type in order for the players to participate. For example, an adventure simulation game is provided that each player is able to build the virtual character with different strengths including life, power, attack, defense, and speed. Each player must well-utilize the strengths of the virtual character to interact with other virtual characters and to complete the pre-set tasks or missions. In other words, such simulation game can only allow the player to play one single type of game with the own virtual character.

As the simulation game becomes popular, the players not only desire greater interactivity to different players but also need better reality that the virtual character can play a role in the real world.

In addition, e-commerce is a new form of business combining ordinary commercial behaviors with network technology for buying and selling products and services over electronic systems including Internet and other computer networks. Instead of purchasing a product in a retail store, people are able to buy and sell products online. Customers may only require an Internet-enabled device, such as personal computer, smart phone, or a tablet computer, to complete the commercial transaction.

Web-advertising becomes a major financial support for the website while Internet becomes more and more important in our life. In fact, some websites cannot be survived without the sponsoring by the commercial advertiser. In other words, the commercial advertisers are willing to sponsor the popular websites because thousands of visitors visit that websites daily. Therefore, how to keep the visitors to stay longer at the website, how to deal with the suppliers and customers, and how to interact among the users are the major concerns for the website owner.

For example, “Amazon.com” is the world's largest online retailer for the users to buy and sell their products. People may simply search the desired product from this shopping site. If the price of the desired product is right, he or she may place a purchasing order through the shopping site. Otherwise, the visitors may randomly search different products through the shopping site. However, such shopping site cannot encourage the visitors to stay on this site. In addition, the shopping site cannot promote any product effectively since most visitors are looking for the lowest price of the product.

“Youtube.com” is another example being successfully recognized and is a video-sharing website for allowing the users upload their video thereat and watching the video for free. The video-sharing website can encourage the user to stay on the site by watching the video. However, interaction between users is limited that the users can only leave comments for the providers. Some of the comments can be junk messages as well.

In view of above, no existing website provides a mutual benefit for the product suppliers and the users, especially when one user purchases the product through the website, another user will not receive any benefit. In other words, the above mentioned websites are the “one supplier-to-one customer” or “one user-to-one user” web business structure.

### SUMMARY OF THE PRESENT INVENTION

The invention is advantageous in that it provides an interactive character simulation system and method thereof, wherein the user is able to create a virtual character to have greater interactivity with others.

Another advantage of the invention is to provide an interactive character simulation system and method thereof, wherein the virtual character built by the user can be establish and interacted in reality.

Another advantage of the invention is to provide an interactive character simulation system and method thereof, wherein an interactive society is formed based on the architecture of the real world that the user is able to live and experience the different styles in the interactive society.

Another advantage of the invention is to provide an interactive character simulation system and method thereof, wherein the advertisements are implanted into the places and products in the interactive society such that the user will be imperceptibly influenced in the interactive society.

Another advantage of the invention is to provide a method and system for promoting product, service, and/or intelligent information through Internet, wherein the users are able to receive different kinds of rewards by staying longer on the platform.

Another advantage of the invention is to provide an educational platform for encouraging the user to learn, wherein the users can learn and play at the educational platform in order gain different experiences in daily life. The system of the present invention forms the educational playground for the users to play and learn at the same time and combines with the merchants to support the education in the educational platform.

Another advantage of the invention is to a web business system, wherein the platform, especially a web-based platform, is provided to link with the product suppliers and users as the customers, and to interact among the users.

Another advantage of the invention is to a web business system, wherein the platform forms a direct link for dealing with the product suppliers and customers and for promoting a brand name on the platform.

Another advantage of the invention is to a web business system, wherein the platform forms an interacting link to enhance the interaction among the users.

Another advantage of the invention is to a web business system, wherein the platform forms a user experiencing link to enable different users showing off their talents and getting rewards at the same time.

Another advantage of the invention is to a web business system, wherein the users are able to receive a discount of a product by staying longer on the platform.

Another advantage of the invention is to a web business system, wherein the users are able to obtain different types of funds from the platform.

Another advantage of the invention is to a web business system, wherein the users are able to earn credits from the platform by uploading the video clip on the platform.

Additional advantages and features of the invention will become apparent from the description which follows, and may be realized by means of the instrumentalities and combinations particular point out in the appended claims.

According to the present invention, the foregoing and other objects and advantages are attained by providing an interactive character simulation system which comprises an interactive society involving places and products being simulated as a real social network, and an user interactive module adapted for a user to configure a virtual character and to play a role in the interactive society, and a business module implanting different advertisements into places and products in the interactive society to interact with the user.

In accordance with another aspect of the invention, the present invention comprises an interactive character simulation method which comprises the following steps.

(1) Provide an interactive society involving places and products being simulated as a real social network, wherein a user is able to access the interactive society through a communication network.

(2) Provide a user interactive module for the user to configure a virtual character in order to play a role in the interactive society.

(3) Provide a business module for implanting different advertisements into places and products in the interactive society to interact with the user.

In accordance with another aspect of the invention, the present invention comprises a web business method through Internet, comprising the steps of:

(1) posting a promotion on a platform through Internet, wherein one or more of users are able to access the platform to view the promotion; and

(2) providing a reward in response to the promotion when the user keeps staying on the platform in a time manner.

In accordance with another aspect of the invention, the present invention comprises a system for web business through Internet, comprising:

a platform adapted for posting a promotion thereon and allowing one or more of users to access said platform to view said promotion; and a reward center linked to the platform for providing a reward in response to said promotion when said user keeps staying on said platform in a time manner.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of an interactive character simulation system according to a preferred embodiment of the present invention.

FIG. 2 is a flow chart of an interactive character simulation method according to the above preferred embodiment of the present invention.

FIG. 3 is a block diagram illustrating the system according to a preferred embodiment of the present invention.

FIG. 4 is a flow chart illustrating the product promoting module of the system according to the above preferred embodiment of the present invention.

FIG. 5 is a flow chart illustrating the user interacting module of the system according to the above preferred embodiment of the present invention.

FIG. 6 is a flow chart illustrating the user experiencing module of the system according to the above preferred embodiment of the present invention.

### DETAILED DESCRIPTION OF THE PREFERRED EMBODIMENT

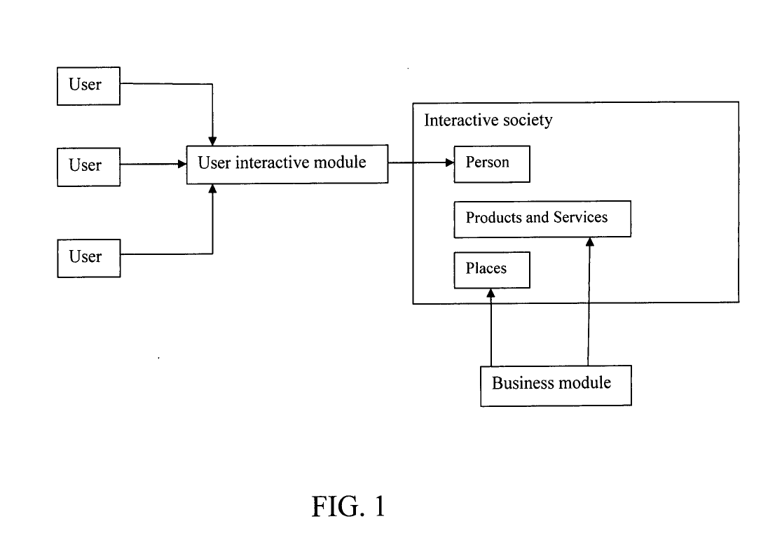

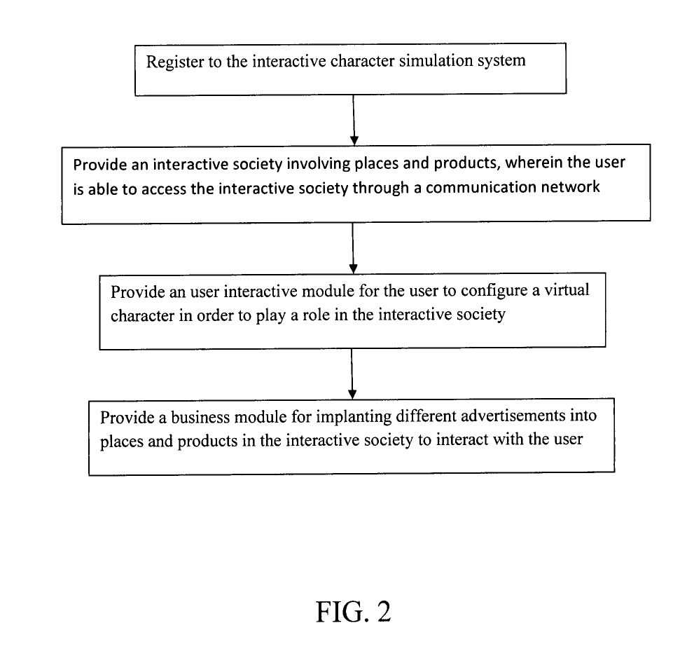

Referring to FIGS. 1 and 2 of the drawings, an interactive character simulation system and method thereof according to a preferred embodiment of the present invention is illustrated.

The interactive character simulation system can establish the social relations through communication network. The system provides an online platform for different users to interact with each other. Each user is able to access the system by using computer, smart phone, or other Internet-enable devices.

Each user is able to obtain his or her own unique identification number (ID number) from the system. The system will create a virtual society that each user will become the resident of the interactive society. The interactive society is formed based on the architecture of the real world, wherein the user is able to live and experience the different styles in the interactive society.

The interactive society is formed to involve people, places, and events. The user is the virtual character in the interactive society. The virtual character can be a configured as a new born baby to start the life at the beginning and to learn everything in the interactive society.

The places in the interactive society are the same as the places in the real world. In particular, the environmental conditions of the place in the interactive society are the same as those in the real world. For example, today is a snowy day in New York, and New York in the interactive society is also a snowy day. Therefore, the virtual character may get cold if the virtual character does not dress properly.

The ID of each user will be represented by a group of meaningful numbers. For example, the first number group, such as first three digits, of the ID will represent the country code of the user. The second number group, such as fourth to sixth digits, of the ID will represent the city code or area code. The third number group, as such the seventh digit, of the ID will represent the sex of the user. The fourth number group, as such the last seven digits, of the ID is a group of random number for personal identification. The ID will also represent the mailing address, email address, bank account, and blog code as well. In other words, the ID of the user is a uniform number for multiple functionality and a unique number generated by the system for one particular user. In addition, a nickname can be created by the user along the ID. The ID can be stored in a card as an ID card or in an electronic device such as a smart phone.

The ID can also be included an organization number group that the corresponding organization must be registered to the system of the present invention. Therefore, the number(s) of the organization number group will be shown in the ID. In other words, when the organization number group is shown in the ID, the corresponding user is recognized that he or she belongs to the particular organization.

According to the preferred embodiment, the system of the present invention provides the interactive society between real and virtual world for constituting a real social network. The system provides a user interactive module for enabling the user to configure a virtual character to play a role in the interactive society. In the interactive society, a virtual family society is formed for the users. Accordingly, each user is able to create the virtual character having a virtual ID based on the ID assigned by the system.

In other words, each user will have the ID in response to a real world and the virtual ID in response to the virtual world.

The user is able to configure the virtual character with age, gender, educational attainment, and wealth level in the interactive society.

The user is able to select different ages to gain the user experience that he or she has never gain. For example, a twenty years old user can configure the virtual character at fifty years old to learn different life experience at different ages. Likewise, a forty years old user can configure the virtual character at eighteen years old for enjoyment of the perpetual youth. A male user can select a female virtual character to discover what women desires.

The user is able to configure the educational attainment of the virtual character. However, the user must pass the educational examination in the system in order to reach the educational level in the interactive society of the system. The educational examination is not equivalent to the educational examination in the real world. Accordingly, a high school graduated user can pass the educational examination in the interactive society to become a PHD thereof.

Once the user is registered to the interactive society, the system will initially give the user a predetermined amount of virtual credits, such as 5 million credits. The virtual credits can be considered as a startup capital for the user to build his or her career. Accordingly, the users are responsible for building their own careers in the interactive society. They can become a billionaire or a debt-ridden people in the interactive in the future. At the same time, each user will also build their social status. All users will start the social status at the same level. Unlike the real world, the polarization between the rich and the poor is the most serious issue. However, in the interactive society, all users are equal initially. They can enhance their social status biased on the life experience, educational attainment, investment, business, luck and other aspects of performance in the interactive society. In other words, the user may be a student in the real world but can be a mayor of a city in the interactive society.

In the interactive society, the user is able to select a marital status of the virtual character. The user is able to choose “single” for the virtual character in the interactive society despite he or she is a father of three children. It is worth mentioning that when the user choose “married” for the virtual character in the interactive society, he or she must list the spouse name of the virtual character in the interactive society. Therefore, two different users can be married in the interactive society.

Initially, two virtual characters of two different users as configured as “husband and wife” in the interactive society. The interactive society will initially issue a marriage certificate to the users so as to ensure the legitimate interests in the interactive society. The couple must follow the marriage law in the interactive society. Accordingly, the system will initially give the couple a predetermined amount of virtual credits which is more than a single user.

The interactive society also forms a relation bond between family members in the real world. For example, the father can ask embarrassing question to his son in the interactive society.

When the user selects a single status for the virtual character, he or she can date and marry to other users in the interactive society. Likewise, the interactive society will issue a marriage certificate to the users and the marital status of the virtual characters will change from single to married. The couple can also get divorced in the interactive society and the property they commonly own will be evenly split.

The system allows a couple having a child in the interactive society. The couple can submit a family plan to a family department in the interactive society. After the family plan is approved, the family department will send a notification to the couple such that a pregnancy status will be shown in the married status. The couple in the interactive society will enjoy the “social welfare” provided by the interactive society. If the family plan is not approved by the family department, the couple can still add the pregnancy status to the married status. However, the couple in the interactive society cannot enjoy the “social welfare” provided by the interactive society. In addition, the child may not be able to attend public school in the interactive society when he or she grows up.

In the real world, pregnancy lasts ten months referring to the pregnancy calendar. In the interactive society, the pregnancy status will also last ten months referring to the time of the interactive society. However, the time lapse in the interactive society is different from the time lapse in the real world. For example, one day in the interactive society may be equivalent to one month in the real world. In addition, routine prenatal tests are required for the “pregnant” user at every prenatal care visit in the interactive society. Prenatal care is recommended for the “pregnant” user before and during pregnancy for medical and nursing care.

It is worth mentioning that the pregnant symptoms will show up in the virtual character. Therefore, it could be a valuable experience for the user that she never experience in the real world. Of course, the user will also plan how to give birth by natural delivery or caesarean section.

According to the prenatal care of the users, the health and intelligence of the child is configured by the system.

In addition, the way of fertility, parenting, and education in the interactive society are the same as those in the real world. However, the parents in the interactive society will use virtual credits instead of money in the real world. The time lapse in the interactive society is also different from the time lapse in the real world. It is worth mentioning that a limited amount of virtual credits can be converted from the money in the real world. Therefore, the users have to earn the virtual credits in the interactive society.

The user is able to add the family members in the interactive society. In the real world, the couple may not able to have more children due to the family planning policy of the government, economic situation, or energy constraint. The parent in the interactive society can have two or more children, as “brother and sister” by applying the family plan to the family department. Once the baby is born in the interactive society, the system will assign an ID to the baby and will issue a birth certificate for the baby. The interactive society will assign a blood type for the baby according to the blood types of the parent, will create a virtual appearance of the baby simulated from the parent, and will build a personality characteristics of the baby. The baby will cry when he or she feels hungry or any uncomfortable. The baby will smile when he or she is happy. The parent can interact with the baby in the interactive society. In addition, the parent must feed the baby, change the diapers, and pet the baby sleep frequently. It is worth mentioning that the baby in the interactive society can be a real child of the parent in the real world or a virtual character created by the parent.

The difference between the real world and the interactive society is that the user is able to select the time lapse in the interactive society. For example, the user is able to set the child be always stayed at five years old. Therefore, the user can always play with the five years old child in the interactive society.

Accordingly, in the real world, the children are married and have their own families. They will have less time to spend with their parents or grandparents. In the interactive society, the user is able to create a virtual character who look alike the grandchild such that the virtual character can always play with the user in the interactive society.

The virtual character created by the user will live in the interactive society simulated by the real world. For example, the address of the virtual character in the interactive society can be found in the real world. The user is able to purchase and sell the house in the interactive society to other users by using virtual credits. In other words, the user may live in an apartment in the real world but his or her virtual character can live in a luxury mansion in the interactive society. However, the luxury mansion in the real world maybe owned by other people. In the interactive society, the luxury mansion is vacancy and is available to sell by auction or other purchasing channels at the beginning.

The user is able to do all kinds of investments in the interactive society. The way of investment in the interactive society is the same way in the real world. In the real world, the user may gain or loss money for investment. Likewise, the user may gain or loss virtual credits for investment in the interactive society. However, the user can take a risk to invest in the interactive society but can be very conservative investor.

The user is able to buy and sell stocks in the interactive society in order to earn virtual credits. An interactive stock exchange is formed in the interactive society to allow the user to trade any stock in any stock market such as “Nasdaq” or “Dow Jones”. The quote of each stock in the interactive stock exchange is the same as that in the real world. In other words, when the stock drops 1% in the “Nasdaq”, that stock in the interactive stock exchange will equivalently drop 1%. Therefore, the user may earn virtual credit or loss virtual credit in the interactive stock exchange. Accordingly, the user may pay a transaction fee to the interactive stock exchange.

The user is able to trade “Futures” in the interactive stock exchange. The futures prices of gold, oil, soybeans, corn, copper, iron, etc. . . . in the interactive stock exchange will be the same as those in the real world. It is worth mentioning that the user is able to trade the stock and Futures in the interactive stock exchange at any stock market internationally. However, most users are restricted to trade stock and Futures in local stock market.

The user is able to invest the real estate market in the interactive society. The user is able to buy and sell houses to gain virtual credits. The user is also able to apply the loan in the interactive society for real estate construction, such as buying lands or houses. Accordingly, the prices of the houses in the real world reflect the prices of the houses in the interactive society.

Accordingly, all the achievement in the interactive society will only be recognized by other users in the interactive society and will not affect the user's life in the real world. In other words, the users are able to make their dreams come true in the interactive society.

The user can also able to apply a credit card in the interactive society. Simulating from the real world, the user will have a predetermined credit line for the credit card to spend. Likewise, the user is able to gamble and buy lottery in the interactive society.

The virtual character created by the user will follow the same laws and rules in the real world. The virtual character may get sick and the user must send the virtual character to visit the doctor. Doctors, nurses, medical staffs will work in the hospital in the interactive society as in the real world. The user will also have to pay for the medical bill to the hospital by using the virtual credits.

Education for child in the interactive society is a must. The child will go to kindergarten, elementary, middle, high school, and college as the same educational path in the real world. The user will have to pay for the tuition. The user can also send the child to different schools with higher educational rankings which depends on the development of the child in the interactive society. For example, when the user takes good care of the child, the child will be evaluated by the system for qualifying the admission of the higher ranked school. It is worth mentioning that since there is not restriction on nationality in the interactive society, the child can apply to any school in the interactive society.

As a citizen of the interactive society, the user is able to own a pet. The pet is also a virtual pet but is required to take care as in the real world. The user is able to buy or adopt the pet in the interactive society. However, the user must feed the pet by buying the pet food and placing the pet food in the container in order to let the pet to eat. If the pet is sick, the user must bring the pet to pet hospital. Therefore, the user has responsibility to take care the pet in the interactive society.

By simulating the city plan of the real world, the city plan in the interactive society will be the same as that in the real world. The urban network, such as subway, airports, highways, roads, in the interactive society will be the same as that in the real world. The user is able to purchase a car in the interactive society or take a panel to fly somewhere. The user must obtain a driving license in the interactive society in order to drive the car in the interactive society and will be ticketed when he or she disobey the traffic laws. The user must pay for the fine by the virtual credits.

Accordingly, all the items and products in the interactive society can be found in the real world. The business module of the system will implant different advertisements into places and products in the interactive society to interact with the user. For example, the user is able to purchase a car from different vehicle manufacturers such as “BMW” or “Honda”. The user may select the diapers made by brand A or B. All the daily products can be sponsored by the companies in the real world as the advertising fee. However, there will be commercial-free in the interactive society that no commercial or advertisement will be posted to interrupt the life of the virtual character in the interactive society. In other words, when a flower shop A pays the advertising fee for the system, the flower shop A will be shown in the interactive society when the user shops for the flowers. It is worth mentioning that the user can buy the flowers as the virtual image from the flower shop A by using the virtual credits such that the brand of flower shop A will be displayed for advertising purpose only.

The users can plan the gardening and landscape design for their house in the interactive society. The user can buy trees, flowers, garden décor, and furniture to create a beautiful yard. However, the user must maintain the yard by weeding, fertilizing, and watering in the interactive society. The yard maintenance in the interactive society will be the same as that in the real world.

It is worth mentioning that the user can enjoy the life in the interactive society that the user may not able to do the same thing in the real world. For example, the user may not able to afford to have a yard in the real world. However, he or she is able to create the landscape design for his or her house in the interactive society.

The social norms in the interactive society will be the same as that in the real world. The virtual character built by the user will live in the interactive society with all the real things in the real world. In other words, the interactive society in the system is established between real and virtual worlds.

The user can live, learn, work, and play in the interactive society. The user will face and interact with different users in the interactive society as in the real world. The user may success or fail in the interactive society. However, the life impact in the interactive society will be minimized comparing to the real world. Therefore, the user can bravely try different things in the interactive society that he or she may not able to try in the real world.

Through the system, the users can establish a new relationship between each other. The user may not have a brother or sister in the real world. However, he or she can have more than one brother or sister in the interactive society.

According to the preferred embodiment, the user can also create a virtual character as a movie star to play in a movie. The system will create different drama series that the user is able to select a role to play in one of the drama series. For example, there are twenty roles in a first drama that the user can pick one of the roles in a first come first serve manner. Then, different users will play in the same drama to interact with each other. It is worth mentioning that different users, different business related products, and different locations are introduced in the drama. Therefore, the businesses can sponsor in the drama and the related products and/or services will show in the drama.

The user is able to try an unrealistic experience in the interactive society. For example, the user is able to fly a spacecraft for space travel in the interactive society. The user will participate the training in the interactive society. The user is able to become a billionaire in the interactive society to drive a yacht, to own a jet, or to stay in a luxury hotel. Or, the user is able to travel the world in the interactive society. It is worth mentioning that people, business related products, and locations are three major elements and are introduced in the interactive society.

Accordingly, the advertisements are implanted into the places and products in the interactive society. The user will be imperceptibly influenced by the products in the interactive society. In other words, the user will use all the products in the interactive society which are sponsored by different businesses. For example, when the user purchases a fight ticket, different airline companies will show in the interactive society for the user to select. When the user buys the groceries, different grocery stores will show in the interactive society for the user to select. It is worth mentioning that the user is able to enter the corresponding business website by a click of mouse at the corresponding advertising location in the interactive society.

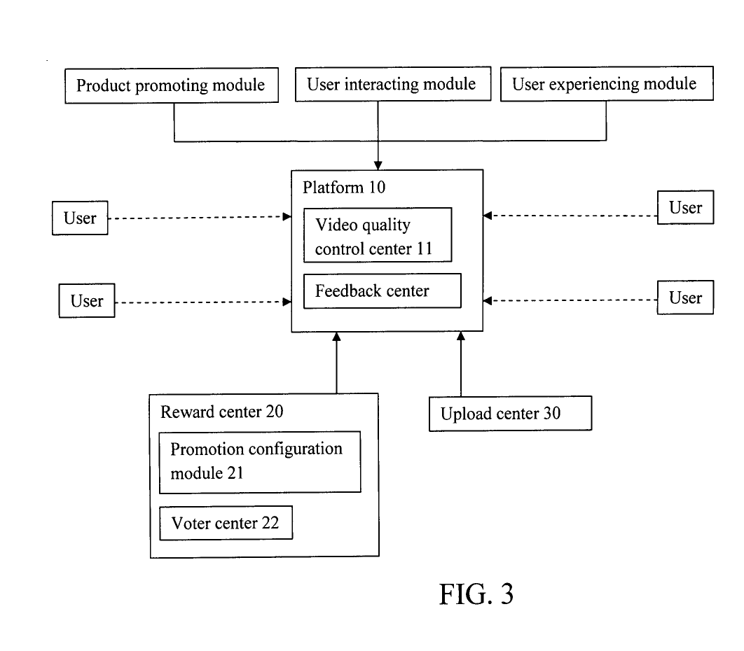

Referring to FIG. 3 of the drawings, a web business method and system for promoting product, service, and/or intelligent information through Internet is illustrated, wherein the system of the present invention comprises three major modules, which are product promoting module, user interacting module, and user experiencing module. Accordingly, the user interacting module further provides the above mentioned interactive character simulation system and method thereof, wherein the user is able to create a virtual character to have greater interactivity with others.

The web business of the present invention comprises a platform 10 for enabling a plurality of users to access by any electronic device through wireless communication network. Accordingly, the electronic device can be a personal computer, smart phone with mobile communication network such as “Edge”, 3G or 4G, “WiFi” enabled computerizing device, or the like.

The present invention further comprises a reward center 20 linked to the platform 10 for providing a reward in response to the promotion when the user keeps staying on the platform 10 in a time manner.

Each module forms a web page on the platform 10, wherein the users are able to select one or more modules to be displayed on the platform 10 according to their preferences.

According to the present invention, the main objective of the web business is to keep the users to stay at the platform 10 as long as they can in order to achieve the high web traffic of the web business so as to increase the popularity of the web business.

Accordingly, the web business method of the present invention comprises the following steps.

(1) Post a promotion on the platform 10 through Internet, wherein the users are able to access the platform 10 to view the promotion.

(2) Provide the reward in response to the promotion when the user keeps staying on the platform 10 in a time manner.

An advertisement or a promotion product can be posted by the commercial advertisers on the platform 10. Therefore, as the users stay longer on the platform 10 the advertising power will become stronger to deliver the message to the user. On the other hands, the longer the user stays on the platform 10, the more the user obtains the reward. In other words, there is a win-win situation for both the users and the commercial advertisers.

As it is mentioned above, all three modules can keep the user to stay longer on the platform 10. The following will explain how to keep the user to stay longer on the platform 10 through each module.

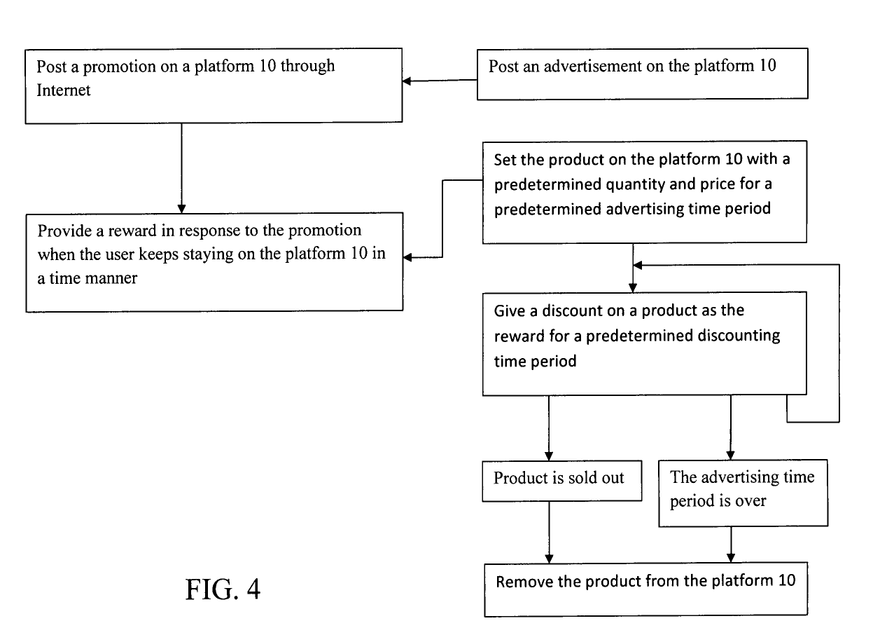

As shown in FIG. 4, the product promoting module is in form of shopping website that the product promoting module forms a marketplace for the users to purchase products. A product search engine is incorporated in the product promoting module for the user to search a particular product. Meanwhile, a promotion product list is posted on the platform 10, wherein the product is posted on the platform 10 with a predetermined quantity and price for a predetermined advertising time period. By searching the promotion product list, the users are able to find out the desired product want to be purchased.

In order to provide the reward to the users, the step (2) further comprises the following step.

(2.1) Give a discount on the product, such as the promotion product, as the reward for a predetermined discounting time period. Therefore, the users are able to purchase the product with a discount price.

According to the preferred embodiment, the reward center 20 comprises a promotion configuration module 21 for configuring the discount on the product for a predetermined discounting time period and for configuring a predetermined quantity and price for a predetermined advertising time period. The promotion configuration module 21 is arranged for removing the product from the platform 10 when the quantity of said product is zero or when the advertising time period is over.

For example, the product will be discounted for 12 hours. After the advertising time period is over, the product will be returned back to its original price. On the other hand, the discount is continuously given for every discounting time period. For example, 10% discount will be continuously given for every one hour. Therefore, after five hours, 50% discount will be accumulatively given the product.

Accordingly, the longer the user stays on the platform 10, the more the discount will be given to the user. Therefore, the user is willing to stay longer on the platform 10 and to wait for a big discount on the product.

Since more than one user will try to wait for the big discount on the product, they will purchase the product at a reasonable price before the product is sold out. Therefore, the users will keep their eyes on the platform 10 to check the quantity of the product. In other words, they will not leave the platform 10 within the discounting time period.

The advertising time period and the discounting time period are shown on the platform 10. In particular, the advertising time period is set in a counting down manner. Therefore, the users will notify how much time is left for the advertising time period. Likewise, the discounting time period is also set in a counting down manner, so as to notify the users how much time being left for giving the discount on the product. Accordingly, the promotion configuration module 21 is configured to set the advertising time period and the discounting time period that the advertising time period and the discounting time period will start at the same time.

It is worth mentioning that the discount is continuously given for every discounting time period by the promotion configuration module 21 until the advertising time period is over or until the product is free. In other words, once the advertising time period is expired, no discount will be given to the product that the users must purchase the product at the original price or must wait for next advertising time period. On the other hand, when the price of the product is reduced to zero, i.e. the product is free, no discount will be further given to the product, since the users can purchase the product for free. However, the quantity of the product is limited, the users will rush to purchase the free product before the product is sold out.

As one of the strategies that the users may purchase the product with relatively low price before the product is free. Therefore, it is possible that the product is sold out before it is free. In other words, the users must keep staying on the platform 10 to keep track the quantity of the product, the advertising time period, and the discounting time period. At the meantime, the advertisement will be posted on the platform 10 to deliver the advertising message to the users.

The following is an example to illustrate the operation of the product promoting module. A mp3 player, as the product, is listed on the promotion list, wherein the price of the mp3 player is $100 and the quantity of the mp3 player is 20. The advertising time period for the mp3 player will start at 1:00 pm to 11:00 pm for 10 hours. The discounting time period is set at 1 hour that $10 off will be accumulatively given for every 1 hour, wherein the discounting time period will start at the same time as the advertising time period starts. In other words, after the 10 hours advertising time period is over, the mp3 player will be removed from the promotion list. Accordingly, the mp3 player will sell for $100 for the first hour of the advertising time period since there is no discount at the first hour. After the first hour of advertising time period, the mp3 player will sell for $90 since the first discounting time period is over. After the second hour of the advertising time period, the mp3 player will sell for $80 since the second discounting time period is over. Therefore, the mp3 player will sell for $20 at the last hour of the advertising time period.

On the other hand, some users are willing to purchase the mp3 player for $50, i.e. 50% off from the original price while they will stay on the platform 10 for 5 hours. Therefore, if five mp3 players are sold at that period, the remaining quantity of the mp3 player will be 15. As the users keep purchasing the mp3 player at different discounting time periods, the quantity of the mp3 player will be kept reducing. Before the last discounting time period, i.e. the last hour of the advertising time period, there are only four mp3 players left. Therefore, the users must timely purchase the mp3 player at the lowest price during the last discounting time period. However, it is possible that all mp3 players are sold out before the last discounting time period. In other words, the users must stay on the platform 10 to keep track the advertising time period and the quantity of the mp3 player.

It is appreciated that the platform 10 will also give a hidden discount before the advertising time period is over. For example, a $10 off hidden discount will be randomly given after the fourth discounting time period. Therefore, it is always a surprise for the users when they can stay longer on the platform 10. Likewise, the platform 10 will give the hidden discount at the last minute before the advertising time period is over, that the mp3 player will be free at the last minute. So, the longer the users stay on the platform 10, the better the rewards they can get.

Accordingly, the present invention provides a product suppliers-to-customers platform 10 to interact the product suppliers with the users. The platform 10 forms a direct link for dealing with the product suppliers and customers. In other words, it is welcome for the product suppliers to place the promotion product on the platform 10 as the advertisement while other related products can be promoted to deliver advertising message to the users at the same time.

Especially for promoting a brand name on the platform 10, more users will rapidly find out the brand name through the platform 10 to achieve the goal of advertisement. In addition, a feedback of the product will be posted on the platform 10 from the users. Therefore, the product is easily popular through the platform 10 when positive feedbacks are posted and thousands of users stay on the platform 10 trying to purchase with the lowest price. A product rating will also be posted on the platform 10 by different users as well.

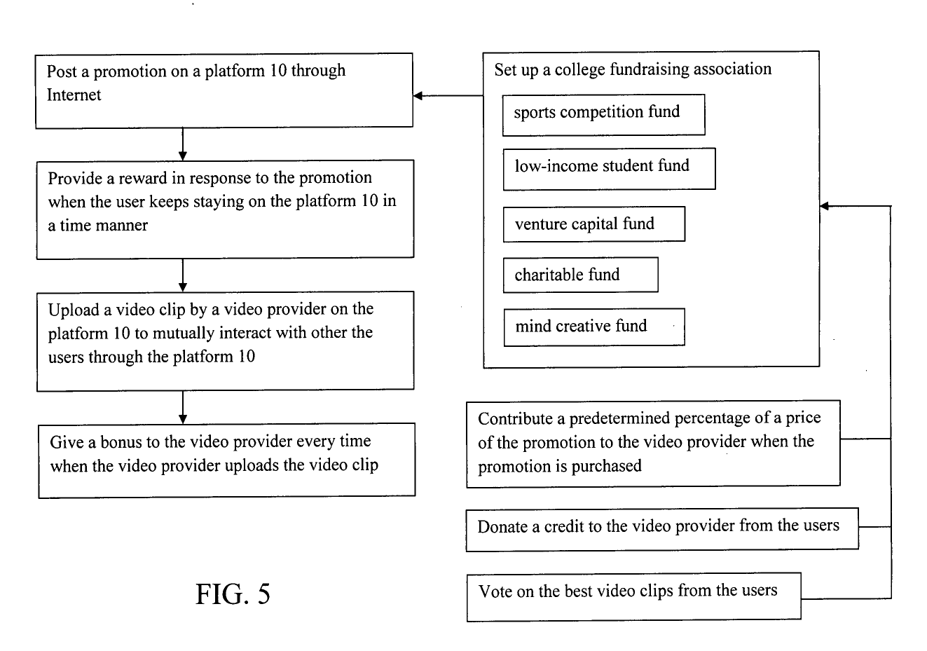

FIG. 5 and the following will explain the user interacting module. Accordingly the platform 10 is formed as an interacting platform 10 that enables different users interacting with each other. The system of the present invention further comprises an upload center 30 for enabling uploading a video clip by a video provider as one of the users on the platform 10 to mutually interact with other the users through the platform 10. In other words, when one video clip is uploaded to the platform 10 to share with other user, other users are able to view the video clip and to interact with the video provider. For encouraging the users to upload their video clips, a bonus will be given to the video provider every time by the reward center 20 when the video provider uploads the video clip. The bonus can be money, credit, or the like. Therefore, the users are willing to stay longer on the platform 10 to upload and/or watch the video clip while the promotion is provided on the platform 10.

In particular, the platform 10 is a student interacting platform 10 for college students. Accordingly, a college fundraising association will be set up through the reward center 20 for encouraging the video provider to bring the video clip on the platform 10, wherein the video provider must be a college student in order to join the college fundraising association. Therefore, after joining the college fundraising association, the users can upload their video clips on the platform 10 for sharing.

In order to keep the users staying longer on the platform 10, the users can view the video clip for free. Therefore, the advertisement will be posted on the platform 10 to deliver the advertising message to the users at the same time when the users watch the video clips. For further encouraging the users to upload their video clips, a predetermined percentage of a price of the promotion will be contributed to the video provider when the promotion is purchased. For example, 1 cent or 1 credit will be given to the video provider when the promotion is purchased. At the meantime, the users can also donate the credit to the video provider.

Accordingly, the college fundraising association has different fund categories for different types of college students. Therefore, the college students can join the college fundraising association in order to apply for the funds and/or scholarships as a reward for the users to stay on the platform 10. The college fundraising association will set up a fund period having a starting time and an ending time, wherein the college students should apply different funds timely before the starting time of the fund period. The results will be published after the ending time of the fund period.

In addition, the reward center 20 comprises a voter center 22 linked to the upload center 30 for allowing the users to vote on the best video clips from different college students that one of more winners of the college students with the highest votes earn respective the fund.

The college fundraising association contains a sports competition fund offering scholarships and supporting to the college students as college sports teams at participating colleges. Preferably, a predetermined percentage of a price of the promotion will be contributed to the sports competition fund when the promotion is purchased. Therefore, the more the promotions are purchased, the higher the sports competition fund is collected.

One of the team members of each college sports team as an applicant can apply for the sports competition fund. The requirements are that the applicant must present the background, the financial difficulty, team schedule, the team budget, and the like regarding the team. Once the application is accepted, the team may have a chance to obtain the sports competition fund.

The applicant, i.e. also the video provider, must upload the video clip on the platform 10 to share with other users, wherein the video clip is a team video having a content including live sports game of the college sports team, team practicing, and/or cheerleading squad performance of the college sports team.

In order to support the team, the users, especially the same colleagues, will stay on the platform 10 to watch the video clips and to purchase the promotion through the platform 10. The users can also post the comments on the platform 10 to support the corresponding teams. Especially during the live game broadcasting on the platform 10, two different groups of users will post different comments in live time manner to enhance the interact among the users.

The users will vote on the best video clips from different college sports teams, wherein a winner of the college sports team with the highest votes wins the sports competition fund. It is appreciated that the sports competition fund can also be applied to high school sports teams, non-profile sports teams and/or professional sports teams.

### Financial

The college fundraising association further contains a financial relief fund. A low-income student fund is considered as one of the financial relief fund offering scholarships and supporting to low-income college students at participating colleges.

Preferably, a predetermined percentage of a price of the promotion will be contributed to the sports competition fund when the promotion is purchased. Therefore, the more the promotions are purchased, the higher the low-income student fund is collected.

The college student as an applicant can apply for the low-income student fund. The requirements are that the applicant must present the background, school GPA the financial difficulty and plan, and the like regarding the educational information. Once the application is accepted, the college student may have a chance to obtain the low-income student fund. It is worth mentioning that the applicant can apply the low-income student fund for his or her colleague but the requirements must be the one who wish to get the low-income student fund.

It is worth mentioning that the college student as an applicant can apply for the financial relief fund due to the emergency or natural disaster of the student and the family thereof. For example, the student, who is the victim of the earthquake, is able to apply for the low-income student fund.

The applicant, i.e. also the video provider, must upload the video clip on the platform 10 to share with other users, wherein the video clip is a personal video to present the background of said video provider.

In order to support the low-income college students, the users, especially the same colleagues, will stay on the platform 10 to watch the video clips and to purchase the promotion through the platform 10. The users can also post the comments and/or encouragement on the platform 10 to support the low-income college students. Preferably, twenty low-income college students will share the low-income student fund.

The users will vote on the best video clips from different low-income college students, wherein a winner of the low-income college student with the highest votes wins the low-income student fund. It is appreciated that the low-income student fund can also be applied to high school students, and/or post educational students.

Likewise, a predetermined percentage of the price of the promotion will be contributed to the applicant when the promotion is purchased. The users can also donate a credit and/or money to the applicant. Therefore, even though the applicant cannot get the low-income student fund finally, the applicant can still get a small amount of fund.

The college fundraising association further contains a venture capital fund supporting to college students to startup their businesses. Preferably, a predetermined percentage of a price of the promotion will be contributed to the venture capital fund when the promotion is purchased. Therefore, the more the promotions are purchased, the higher the venture capital fund is collected.

The college student as an applicant can apply for the venture capital fund. The requirements are that the applicant must present the background, school GPA, the financial difficulty, business plan, and the like regarding the business information. Once the application is accepted, the college student may have a chance to obtain the venture capital fund.

The applicant, i.e. also the video provider, must upload the video clip on the platform 10 to share with other users, wherein the wherein the video clip is a personal video to present the background and skillful of the video provider and to present a proposal of the business.

In order to support the college students, the users, especially the same colleagues, will stay on the platform 10 to watch the video clips and to purchase the promotion through the platform 10. The users can also post the comments and/or encouragement on the platform 10 to support the college students.

The users will vote on the best video clips from different college students, wherein a winner of the college student with the highest votes wins the venture capital fund. It is appreciated that the venture capital fund can also be applied to high school students, and/or post educational students.

Likewise, a predetermined percentage of the price of the promotion will be contributed to the applicant when the promotion is purchased. The users can also donate a credit and/or money to the applicant. Therefore, even though the applicant cannot get the venture capital fund finally, the applicant can still get a small amount of fund.

It is worth mentioning that a professional analysis group, including college professors, businessmen, investors, economists, professional analyzers, will join the college fundraising association to give professional advices and comments to the applicants. However, the members of the professional analysis group are prohibited to vote for the college students. Therefore, even though the applicant loses competition of the venture capital fund finally, he or she will receive valuable advices and comments from the professional analysis group.

The college fundraising association further contains a charitable fund supporting to a non-profit organization. Preferably, a predetermined percentage of a price of the promotion will be contributed to the charitable fund when the promotion is purchased. Therefore, the more the promotions are purchased, the higher the charitable fund is collected.

The college student as an applicant can help the non-profit organization to apply for the charitable fund. The requirements are that the applicant must present the background of the non-profit organization, the financial difficulty, and how to use the fund to help achieve its goals thereof, and the like regarding the non-profit organization. Once the application is accepted, the non-profit organization may have a chance to obtain the charitable fund.

The applicant, i.e. also the video provider, must upload the video clip on the platform 10 to share with other users, wherein the wherein the video clip is an information video to present the background of the non-profit organization and how to use the fund to help achieve its goals thereof.

In order to support the non-profit organization, the users, especially who lives at the same city, will stay on the platform 10 to watch the video clips and to purchase the promotion through the platform 10. The users can also post the comments and/or encouragement on the platform 10 to support the non-profit organizations.

The users will vote on the best video clips from different non-profit organizations, wherein a winner of the non-profit organization with the highest votes wins the charitable fund. It is appreciated that the charitable fund can also be applied to public hospitals, and/or public schools.

Likewise, a predetermined percentage of the price of the promotion will be contributed to the non-profit organization when the promotion is purchased. The users can also donate a credit and/or money to the non-profit organization. Therefore, even though the non-profit organization cannot get the charitable fund finally, the applicant can still get a small amount of fund. It is worth mentioning that the users can be the voluntaries to help the non-profit organization.

The college fundraising association further contains a mind creative fund offering scholarships and supporting to college students with creative mind. Preferably, a predetermined percentage of a price of the promotion will be contributed to the mind creative fund when the promotion is purchased. Therefore, the more the promotions are purchased, the higher the mind creative fund is collected.

The college student as an applicant can apply for the mind creative fund. The requirements are that the applicant must present the background and the like regarding the creative work. Once the application is accepted, the college student may have a chance to obtain the mind creative fund.

The applicant, i.e. also the video provider, must upload the video clip on the platform 10 to share with other users, wherein the wherein the video clip is a personal video to present creative work of the video provider.

In order to support the college students, the users, especially the same colleagues, will stay on the platform 10 to watch the video clips and to purchase the to promotion through the platform 10. The users can also post the comments and/or encouragement on the platform 10 to support the applicant.

The users will vote on the best video clips from different college students, wherein a winner of the college student with the highest votes wins the mind creative fund. It is appreciated that the mind creative fund can also be applied to high school students and/or post educational students.

Likewise, a predetermined percentage of the price of the promotion will be contributed to the college students when the promotion is purchased. The users can also donate a credit and/or money to the college students. Therefore, even though the college students cannot get the charitable fund finally, the applicant can still get a small amount of fund in order to complete the creative work.

It is worth mentioning that a professional analysis group, including college professors, businessmen, investors, economists, professional analyzers, will join the college fundraising association to give professional advices and comments to the applicants regarding the creative work. However, the members of the professional analysis group are prohibited to vote for the college students. Therefore, even though the applicant loses competition of the venture capital fund finally, he or she will receive valuable advices and comments from the professional analysis group. In additional, different comments can be made by different users to improve the creative work of the applicant.

It is worth mentioning that the user is able to vote and contribute a predetermined credit to the student at different fund categories of the college fundraising association. In particular, the user is able to contribute the credit (cash or point) to the applicant and to vote for the applicant through Internet. At the same time, the applicant will receive the credit from the voter as well. In other words, the present invention provides a mutual concern and strong bonding interaction between the voters and the applicants.

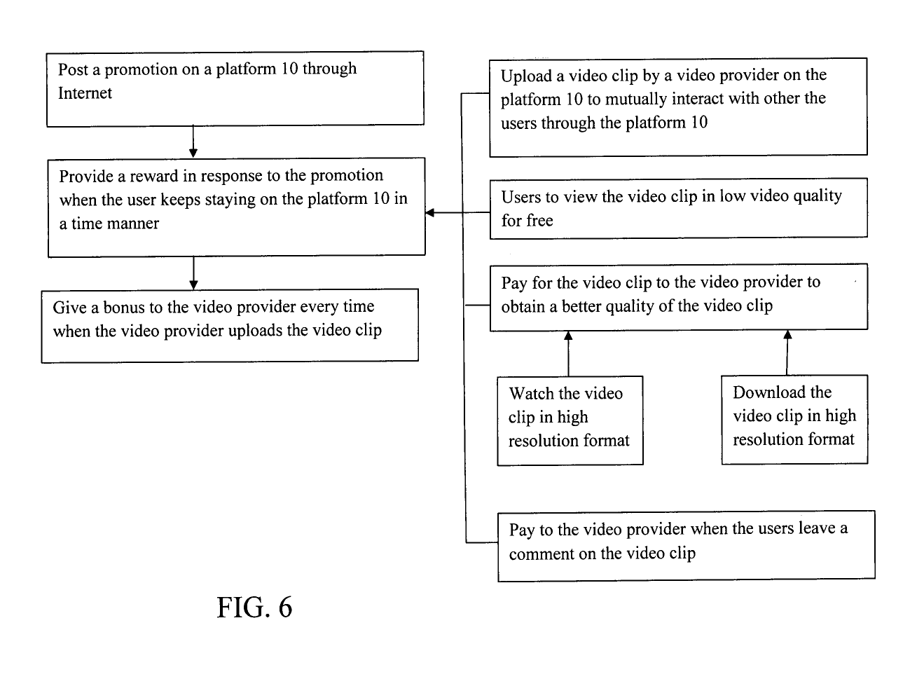

FIG. 6 and the following will explain the user experiencing module. Accordingly the platform 10 is formed as a talent performing platform 10 that enables different users showing off their talents. The method of the present invention further comprises a step of uploading a video clip by a video provider as one of the users on the platform 10 to perform the talent to others through the platform 10. In other words, when one video clip is uploaded to the platform 10 to share with other user, other users are able to view the video clip and to interact with the video provider.

The platform 10 further comprises a video quality control center 11 linked to the upload center 30 for controlling different video qualities of the video clip being assessed by the users.

In particular, the step (2) of the present invention further comprises the following steps.

(2.1) Enable a video provider as one of the users to upload a video clip on the platform 10 to mutually interact with other the users through the platform 10.

(2.2) Allow the users to view said video clip in low video quality for free.

(2.3) Allow the users to pay for the video clip to the video provider in order to obtain a better quality of the video clip.

(2.4) Pay to the video provider when each of the users leaves a comment on the video clip.

In the step (2.1), each user is able to post his or her video clip to show his or her talent such as music, singing, short movie, dancing, or other performance on the platform 10. For encouraging the users to upload their video clips, a bonus will be given to the video provider every time when the video provider uploads the video clip. The bonus can be money, credit, or the like. It is worth mentioning that instead of uploading the video clip, the user is able to upload photos, articles, calligraphy, painting, and the like to show the art works to other users.

In the step (2.2), the users can only watch the uploaded video clip in a low quality manner. In other words, the video quality control center 11 will only permit the user to watch the low resolution video clip for free. For example, the users are free to watch the video clip in a relatively small window area on the display. In other words, the video clip can be considered as a preview to let other users to watch for free.

If the users like the video clip and want to watch it in better quality, i.e. in high resolution format, the users must pay for the video provider as an encouragement or achievement as a reward for the users to stay on the platform 10 in the step (2.3). Accordingly, the video quality control center 11 will permit the users to access the high resolution video clip after the users pay for the video provider. It is worth mentioning that when the photo is uploaded, the user can only view the photo in a low quality manner. Otherwise, the user must pay for the provider to view the photo in high resolution format or to download the photo.

For example, after paying to the video provider, the user is able to watch the video clip in a relatively big window area on the display. In addition, the users must pay for the video provider if they want to download the video clip in better quality. Of course, the value for watching the video clip in better quality should be cheaper than the value for downloading the video clip in better quality. The users should appreciate to pay for the creator, as the video provider, of the original work or talent.

It is always welcome to leave a comment by the user to the video provider. For example, the user is able to leave a professional advice to the video provider. However, it is required for the user to leave a comment to the video provider before the user must pay a predetermined small amount of credit, such as 1 cent, to the video provider. The reason why the user must pay for the video provider before leaving the comment is to encourage more users to upload their talent video clips. In other words, when the video provider receives the credits or moneys from other users, the video provider will also pay for other video providers as a mutual benefit to enhance the hit rate of the platform 10 and to encourage the users to stay longer on the platform 10. In addition, it will also prevent the junk messages left for the video provider. It will also be counted when the junk messages are left to the video provider in order to earn the credit from the user who leaves the junk message.

It is worth mentioning that the user must pay to the video provider when he or she leaves a comment on the video clip. In addition the user must pay to the video provider when he or she leaves a comment on the video clip in response to another comment. In other words, the comment can be a feedback of other comments.

The platform 10 further comprises a feedback center 12, wherein a feedback of the video clip and a rating thereof will be posted on the platform 10 through the feedback center. The video clips will be preferably sorted by rating, the latest date uploaded, or video providers.

According to the present invention, the system is an Internet-based platform to link with the product suppliers and users as the customers, and to interact among the users. The users are willing to stay longer on the platform 10 in order to receive the reward therefrom by having a discount on the product to purchase the product on the platform 10, by obtaining fund from the platform 10, and/or by earning credit from uploading the video clip on the platform 10.

It is worth mentioning that all users are able to obtain the credits from the platform 10 in different ways as mentioned above. The credits can be transferred as a purchasing power that the users can use the credits to purchase the products on the platform 10.

According to the preferred embodiment, the system of the present invention encourages the users using their own information, such as name and ID number, which is the basic foundation of the social network to interact with others. Accordingly, there are many advantages of using the real-name registration. The user will be rewarded in response to the promotion. The user is able to view and comment the video from other users (video providers) and pay for the video provider. The video provider will get paid by other users when they watch the video from the video provider. In order to vote the best video clips, the user must use the real-name registration to pay for the video provider. Using the real-name registration, the user can only vote for one time only and for preventing the user repeatedly vote for the video clip. The user must use the real-name registration to apply the college fundraising association. Using the real-name registration will prevent any material in the system containing pornography or violent contents to a person under the legal age. The system will automatically filter such materials provided by the user. In addition, the system will prohibit the activity of selling cigarettes and alcohols to minors.

Accordingly, advertisements are provided on the platform 10 with the video clip. In particular, the advertisements are targeted in response to the video clip for enabling the user to view and access targeted advertisements in response to the video clip.

Most advertisements are posted randomly from other websites, such that the effectiveness and powerfulness of the advertisements will be substantially reduced. In fact, most advertisements are considered as a spam.

According to the preferred embodiment, the content of advertisements will be implanted in the corresponding content of the video clip. For example, the advertisement of a magic product will be implanted in a video clip of magic show. The advertisement can be an icon located next to the window for displaying the video, such that the advertisement will pop up once the mouse point pointed at the icon. Likewise, the advertisement will be displayed on the window when the video clip starts, ends, or is paused. The advertisement will be directly and automatically linked to the corresponding website for allowing the user to shop.

The users earn a predetermined amount of credits from the system of the present invention, wherein the users are able to spend the credit to buy movie tickets, train tickets, airline tickets, utility bills, telephone bills or as the co-payment of the hospital. Especially for who needs to wait in line for purchasing, the businesses are able to tag on their software to the system of the present invention in order for the user to purchase their products or services through the system. Preferably, the system of the present invention provides a unified platform for enabling different businesses tagging on their software to the system. In addition, the unified platform will connect to the point of sale (POS) terminals of the businesses automatically. Once the users activate their identification (ID) from the system, they can access the unified platform for completing the purchasing from different businesses. In other words, the users will not need to wait in line to purchase the products or services. On the other hand, the business will eliminate the retail of the product and service, such as retail store and salesperson, in order to directly provide the product and service to the users through the system.

The system will charge a predetermined amount of service fee for the unified platform to complete the translation between the business and the user. The service charge of the system is similar to the service charge of the bank service or as the advertising fee.

The system of the present invention provides the unified platform as an online shopping platform, wherein the users are able to access the unified platform through any Internet-enabled device such as mobile phone or computer, wherein the product can be delivered to the user by mail or on-site pick up. The unified platform will also provide a special discount for the users to purchase the products and services such that the user is able to conveniently purchase the products and services through the unified platform with the affordable price. The unified platform will also give a predetermined of bonus points to the user once the translation is completed. The user is able to directly use the bonus point to purchase the product and service through the unified platform without limiting on the particular product or service. In other words, when the user purchases a product from the business A and obtains the bonus point, the user is able to use the bonus point to purchase a service from the business B without limiting the use of the bonus point for the business A only.

Conventionally, in order to obtain a discount from the business, the user must provide the personal information, such as ID number, address, and contact information, to join as a member. Some memberships will also be classified at different levels, such as diamond, platinum, and gold. When the user uses the membership card to purchase the product or service, a certain discount will be given according to the level of the membership. Especially, when the membership card is swiped, all the personal information will be read. The bonus point will then be given and saved in the membership card according to the purchasing amount of the product. The major drawback is that the user must carry the membership card in order to complete the translation. For some powerful shoppers, they may carry tens of the membership cards and remember which card needed to be used before purchasing. In addition, for most small businesses, they cannot afford to establish the card system in order for the users to join as the members. The small businesses may merely issue coupons for the users to purchase their products with discount. However, it is a hassle for the users to hold hundreds of such coupons for shopping.

According to the present invention, the unified platform is an online integrated platform for enabling different businesses tagging on their business service software, similar to the bank POS machine, wherein POS machine cannot be provided at all of the registration counters of the businesses. The unified platform is not tag on the individual business system but provides an integrated platform for incorporating with different service software. In other words, the conventional card system, when the user swipes the card, the POS machine will automatically charges the user and will directly deduct the amount of money to the business. On the other hand, the POS machine of the present invention is provided at each registration counter of the business. The unified platform is communicatively linked to each POS machine to obtain information of the business thereof. The information includes business information, product and service information, and user information. The business information includes registration information of the business to the system of the present invention (the registration information is only permitted to be change by the system of the present invention), business address, contents of business registration, business contact number such as phone number and fax number, information of legal representative, service ranking (ranked by the system of the present invention). The product and service information, which is adapted to change by the merchants through the self-business operation terminal thereof, includes the product name, unit price, quantity, gross weight, net weight, volume, etc. The user information, which is provided by the system of the present invention and is supplementary by the merchant, includes ID card of the user, ID number of the user on the ID card, consumer level, consuming content, accumulated consumption, and bonus points. The merchant does not need to provide an individual database to store the user information. The system of the present invention will provide the user database for the merchant to incorporate with their business system.

The user is able to use the ID card to complete the translation through the POS machine of the present invention. The credits saved in the ID card can be converted for purchasing. Depending on the user's financial situation, a predetermined of credit limit is provided for the user to use. In particular, the merchant directly deals with the system of the present invention for the translation but not deals with the user. The system will automatically record each translation including the product information, quantity, and bonus points.

The system of the present invention further provides an educational platform for educating the user therethrough, wherein the educational platform is formed between the real society and the virtual society. The users interact with each other in the virtual society through the reality of the real society.

In the educational platform, each user has the own ID number as it is mentioned above. The user is able to create a virtual family in the virtual society with the characters, such as age and gender. The user is able to select the age of the virtual character different from the real age of the user. For example, a 30 years old male user is able to create a 18 years old female character in the virtual society. Each user can take an examination in the educational platform provided by the system of the present invention in order to set up an educational level in the virtual society. Accordingly, the examination is provided by the system of the present invention but not the real educational examination such that the user, who is a high school graduated student, can be a PHD in the virtual society once he or she passes the examination in the educational platform. The user can also create his or her own personality for the virtual character.

Once the user is registered in the educational platform, the system of the present invention will automatically give a predetermined amount of credits as the virtual money in order to allow the user to further study in the educational platform or to start his or her business in the educational platform. It is worth mentioning that the education platform enhances the user to experience the real life through the education and/or the business in the education platform. Accordingly, the credits can be considered as the start-up capital, wherein by wisely using the credits, the user to earn more credits to become a billionaire. Otherwise, he or she may become bankrupt depending how he or she spends the credits.

All the users will be at the same starting line of the social status at the beginning. Accordingly, stratification occurs in the virtual society, wherein the class system in the virtual society is made of upper class, middle class, and working class as an example. According to the educational level, working experience, occupational prestige, society class, luck, etc, in the virtual society, the society ranking of the user will be selectively adjusted. For example, one user has a good performance in terms of business, entrepreneurship, investment, and stocks, he or she will gain a higher society status in view of the financial industry in the virtual society. It is worth mentioning that the social status of the user in the virtual society could be totally different from that in the real society. For example, the user can be a working class in the real society but he or she can be an upper class in the virtual society.

The user in the virtual society can choose his or her marital status in the virtual society. Accordingly, the user is able to choose whether he or she is married or single in the virtual society even though he or she is married in the real society. The user is able to create the virtual character in the virtual society to fulfill the happiness in the virtual society. When the user selects whether he or she is married in the virtual society, another user should be registered to the system of the present invention to form a couple. Similar to the real society, the system of the present invention will provide a “Marriage certification” to the couple in the virtual society so as to ensure the user and the spouse having the legitimate rights and interests, such as common property in the virtual society. When two users register in the educational platform at the beginning as a couple, the system of the present invention will automatically give the credits to the couple, wherein the amount of credits will be at least double, preferably 10 times, for the couple comparing with the user being registered as a single.

The user who registers as a single can date any user in the virtual society. The users can then get married in the virtual society. Before they get married, the system of the present invention will notary their properties as the “pre-marital property”. Once they divorce in the virtual society, the system will split their common property and the pre-marital property.

Once the users get married in the virtual society, they can have a baby as well. The couple can submit a family plan to a family planning department of the virtual society. Once the application is approved, the family planning department will send a child approval letter to the couple. Of course, the child is also a virtual character in the virtual society. Having the child approval letter, the couple can obtain social welfare from the virtual society during the “pregnant” period. It is worth mentioning that the couple can have a child without the child approval letter from the family planning department. However, the couple will not obtain any social welfare from the virtual society. Accordingly, the couple can obtain a predetermined of credits as the social welfare from the virtual society.

When the user is “pregnant” in the virtual society, the pregnant time period is considered as virtual period. The pregnant time period may be only two days in the virtual society. For example, one hour time period is equivalent to one month in the virtual society. The user who is pregnant in the virtual society will need extra “nutrition” and “regular pregnancy tests” such that the user can learn the process of pregnancy in the virtual society. According to the performance during the pregnancy period, the health condition, IQ, and the like will be determined by the system of the present invention. In addition, the birth, child care, and education are the same as the reality. However, the cost will be virtually used by the credits. Therefore, the parent must wisely spend their credits for their child.

According to the family planning policy, economic, energy, resource, and other constraints in the virtual society, the parent can have more than one child. Likewise, the parent can submit a family plan to the family planning department of the virtual society to have a second child. It is worth mentioning that the child in the virtual society will have his or her own personality, characteristics, appearance, and blood type according to the personalities, characteristics, appearances, and blood types of the parent in the virtual society. The appearance of the child will be simulated in different forms, preferably 3-5 different forms, for the parent to select. In addition, the parent must learn how to nurture, how to educate, and how to spend time for their child in the virtual society. The parent must feed the baby and change diapers everyday in the virtual society. The baby will cry, grow, learn, and laugh to interact with the parent in the virtual society. The user will learn how to take care the baby in the virtual society.

The system of the present invention will also provide a real estate structure for the user to buy and sell the houses. The geography in the virtual society is completely the same as the real world. In other words, the user is able to purchase a mansion in Beverly Hill or a five star hotel in the virtual society by using the credits. The buildings are exactly the same as in the real world.

The system of the present invention will also provide a stock market for the user to buy and sell the stocks. Stimulating the stock market in the real world, the system of the present invention will provides different virtual stock markets, such as New York Stock Exchange (NYSE), London Stock Exchange, Hong Kong Stock Exchange, and Shanghai Stock Exchange, in order for the user to trade different stocks in different stock markets. The index of each stock in the virtual stock market will be synchronized with the index of the corresponding stock in the real stock market. In other words, when the price of the stock A drops in the real stock market, the price of the stock A will also correspondingly drop in the virtual market. The user is able to trade the stock by the credits provided by the system. Therefore, the user will earn or loss his or her credits through the virtual stock market.

Likewise, the system of the present invention will also provide an option exchange market. The forward rate in the virtual option exchange market will be synchronized with the corresponding forward rate in the real option exchange market.

The user will be an employee or an employer in the virtual society. The user will have a chance to start his or her business in the virtual society to fulfill the dream in the real life. The success or failure of the business will not affect the user's real life but will achieve the dream for the user.

The virtual characters, including the user and the child, will be sick in the virtual society. The virtual character may feel sick during the flu reason when he or she is not taken good care. The user must bring the virtual character to visit the doctor. In the virtual society, the system of the present invention will provide hospital, drugstore, doctors, nurses, and different physicians. The user will learn how to prevent the virtual character being infected by virus and how to take care the virtual character when being sick. The medical charges will be billed to the user and the user must pay the bill by using the credits.

The child in the virtual society must go to school, such as kindergarten, elementary school, middle, school, high school, and college in the virtual society. The parent must select the school for the child according to the educational level of the child. In addition, the parent must spend time for studying with the child in order to obtain higher educational level for the child. The parent will pay for the tuition by credits. The system of the present invention will evaluate the educational level of the child in the virtual society. The parent can send the child overseas by applying different colleges in the virtual society. Therefore, the system of the present invention provides a lesson for the user to learn how to plan the educational stages for the child in the virtual society.

The user is able to own a virtual pet in the virtual society. The user is able to purchase or adopt a virtual pet in the virtual society, wherein the user must frequently feed the virtual pet, bath the virtual pet, walk the virtual pet, and clean up as the user cares the pet reality. The user should bring the virtual pet to the virtual animal hospital when the virtual pet is “sick”. The virtual pet should send to a virtual animal hotel when the user must leave the virtual pet for a period of time. The system of the present invention will check the time period whether the virtual pet is taken good care. For example, the IP address of the user will be checked whether the user must log in to the system of the present invention with the corresponding IP address in order to take care the virtual pet. Therefore, the system of the present invention will let the user to learn how to be responsible for the pet.

The city plan in the virtual society is the same as the city plan in reality. For example, city, roads, streets, and other facilities, such as subway, railway station, airports, and highways in the virtual society are simulated in reality. The user is able to buy a car or take a bus in the virtual society. Of course, the user must follow the traffic law in the virtual society and will be given a traffic ticket when the user disobeys the traffic law.

Accordingly, all the products and services in the virtual society can be found in reality. The user will play at the educational platform for free. However, the merchants will pay for the advertisement when their products or services placed in the virtual society. In other words, the content of advertisements will be implanted in the virtual society. For example, the company selling baby product such as diaper will pay for the advertising fee to the system of the present invention, such that the baby product will be shown in the virtual society. In other words, when the user buys the baby product for the virtual baby, he or she will see the commercial of the baby product. The desired result of displaying the related product is to drive the user behavior with respect to the commercial offering that the user may buy the product in reality: The car manufacturer will pay for the advertising fee to the system of the present invention, such that the user will buy the corresponding car in the virtual society. As a result, the user may subconsciously buy the corresponding car in reality.

The user is able to build his or her own house and plan the landscape design in the virtual society. Accordingly, lawn care is important in maintaining a beautiful home, wherein the user is able to plant trees, shrubs and/or flowers. The user must fertilize the lawn, improve the soil quality, water the turf grass, and get rid of weeds. Therefore, the user will learn the landscape design and lawn care. In particular, the user will also learn different tree species and characteristics.

According to the present invention, the system thereof enables the users to make their dreams come true in the virtual society while they cannot achieve in reality. The environment in the virtual society such that the user will live in the virtual society as he or she in the real society. However, the users can relief their enormous pressure in the real life and achieve their dreams in the virtual society.

Accordingly, the users can learn the meanings of “life”, “engagement”, “entrepreneur”, “investment”, etc in the virtual society. The users can also try different lifestyles and society activities that they cannot try in reality. Even though they may fail their missions in the virtual society, they also can take the risk to retry until they complete their missions in the virtual society. In other words, the users can gain different experiences and learn different lessons to help them to achieve their goals in reality. In the virtual society, the users must also communicate with each other to establish the relationship as they do in reality. The user can introduce friends to other users in the virtual society and can learn how to bond with each other. It is worth mentioning that the system of the present invention will prompt the users and give suggests and advices to the users in order to teach the user how to take care the family member, such as baby, pets, trees, etc. The information will integrated with the corresponding advertisement from the merchant, such that the users can learn different social activates at the same time the merchants can promote their products and services through the educational platform.

In fact, the system of the present invention provides different social activates in order for the users to play through the education platform. The users can learn and play at the same time.

The user is able to learn foreign languages through the education platform. Conventionally, students usually learn foreign languages from the text books, wherein they will talk to each other by their mother languages. In other words, they learn foreign language in a native language environment. It is known that language is a tool of communication, such that the students cannot effective learn the foreign language in a native language environment. In addition, they must pay expensive tuition to learn foreign language. It is worth mentioning that the user needs not only to memorize and understand, but also to practice in order to improve the skill, such that it is accustomed to make the user to involve the physical activities such as speaking, listening, writing, and reading. The system of the present invention provides a communication platform that the users are able to gather and learn different languages through the daily activities. For example, an English communication platform is provided that the users in the English communication platform must use English to communication, wherein they will learn English when they play or eat. They may use English to buy pet food in the store for their pets. They may use English to communicate with the constructors in order to build their houses. They may use English to communicate with the doctor when their children are sick. In other words, they will make them accustomed to using foreign language in daily activities in the virtual society. As a result, they can speak, listen, write, and read foreign language without sitting in the classroom or paying expensive tuition. Likewise, different subjects, such as mathematics, physics, chemistry, history, will be provided, such that the users can learn different subjects and can interact with each other to enhance the educational levels of the users.

Therefore, the system of the present invention forms the educational playground for the users to play and learn at the same time and combines with the merchants to support the education in the educational platform. Through the educational platform, the users will gain different experiences in daily life in order to strengthen the knowledge, skill, and value in reality. The users will also learn how to solve the problem and how to deal with depression, stress, anxiety, and anger in reality. The users will accumulate the knowledge, skill, and value in the virtual society and use them in reality.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An interactive web method, comprising the steps of
(a) providing an interactive society involving places and products being simulated as a real social network, wherein a user is able to access the interactive society through a communication network;
(b) providing a user interactive module for the user to configure a virtual character in order to play a role in the interactive society; and
(c) providing a business module for implanting different advertisements into places and products in said interactive society to interact with the user.

2. The method, as recited in claim 1, wherein said interactive society is formed based on architecture of the real world that environmental conditions of the place in said interactive society are the same as those in the real world, in order to allow the user to live and experience different styles in said interactive society.

3. The method, as recited in claim 1, wherein the step (b) further comprises a step of configuring said virtual character with age, gender, educational attainment, and wealth level in said interactive society.

4. The method, as recited in claim 2, wherein the step (b) further comprises a step of configuring said virtual character with age, gender, educational attainment, and wealth level in said interactive society.

5. The method, as recited in claim 1, wherein, in the step (c), all the products in said interactive society are sponsored by different businesses, so as to enable the user to interact with said businesses in said interactive society.

6. The method, as recited in claim 4, wherein, in the step (c), all the products in said interactive society are sponsored by different businesses, so as to enable the user to interact with said businesses in said interactive society.

7. The method, as recited in claim 1, wherein the step (c) further comprises a step of directly entering a corresponding business website at a corresponding advertising location of said place and product in said interactive society.

8. The method, as recited in claim 6, wherein the step (c) further comprises a step of directly entering a corresponding business website at a corresponding advertising location of said place and product in said interactive society.

9. The method, as recited in claim 1, wherein there is a commercial-free in said interactive society that no commercial is posted in said interactive society.

10. The method, as recited in claim 8, wherein there is a commercial-free in said interactive society that no commercial is posted in said interactive society.

11. The method, as recited in claim 1, wherein said interactive society provides an educational platform not only for encouraging the user to play and learn, but also for combining with merchants to support education in said educational platform at the same time.

12. The method, as recited in claim 10, wherein said interactive society provides an educational platform not only for encouraging the user to play and learn, but also for combining with merchants to support education in said educational platform at the same time.

13. An interactive system, comprising:
an interactive society involving places and products being simulated as a real social network for a user accessing said interactive society through a communication network;
a user interactive module for the user to configure a virtual character in order to play a role in the interactive society; and
a business module for implanting different advertisements into places and products in said interactive society to interact with the user.

14. The interactive system, as recited in claim 13, wherein said interactive society is formed based on architecture of the real world that environmental conditions of the place in said interactive society are the same as those in the real world for allowing the user to live and experience different styles in said interactive society.

15. The interactive system, as recited in claim 13, wherein all the products in said interactive society are sponsored by different businesses for enabling the user to interact with said businesses in said interactive society.

16. The interactive system, as recited in claim 14, wherein all the products in said interactive society are sponsored by different businesses for enabling the user to interact with said businesses in said interactive society.

17. The interactive system, as recited in claim 13, wherein there is a commercial-free in said interactive society that no commercial is posted in said interactive society.

18. The interactive system, as recited in claim 16, wherein there is a commercial-free in said interactive society that no commercial is posted in said interactive society.

19. The interactive system, as recited in claim 13, wherein said business module provides a direct link for entering a corresponding business website at a corresponding advertising location of said place and product in said interactive society.

20. The interactive system, as recited in claim 18, wherein said business module provides a direct link for entering a corresponding business website at a corresponding advertising location of said place and product in said interactive society.
